(19) United States
(12) Patent Application Publication
(10) Pub. No.: US 2026/0352504 A1
(43) Pub. Date: Nov. 5, 2026

(54) Asset Claiming Associated With A Software-Based Room System For Video Conferencing

(71) Applicant: Zoom Communications, Inc., San Jose, CA (US)

(72) Inventors: Karen Kuei Ren Hong, Los Altos, CA (US); Tao Zhang, Hefei (CN); Yu Zhu, Hefei (CN)

(21) Appl. No.: 19/346,904

(22) Filed: Oct. 1, 2025

Related U.S. Application Data
(60) Provisional application No. 63/797,222, filed on Apr. 30, 2025.

(51) Int. Cl. H04L 12/18; H04W 12/50

(52) U.S. Cl. CPC H04L 12/1818; H04L 12/1831; H04W 12/50

(57) ABSTRACT

A computing device located within a physical conference space and connected to a video conference outputs quick response (QR) code rendering data to cause a display device located within the physical conference space to present a QR code. A click command indicative of a claiming request corresponding to a set of assets associated with the video conference is obtained from a participant device located within the physical conference space. Based on the click command, an ownership change operation is facilitated to assign the set of assets to a participant account associated with the participant device.

### CROSS REFERENCE TO RELATED APPLICATIONS

This application claims the benefit of U.S. Provisional Patent Application Serial No. 63/797,222, filed Apr. 30, 2025, the entire disclosure of which is incorporated herein by reference.

### FIELD

This disclosure generally relates to a software-based room system for video conferencing, and, more specifically, to asset claiming associated with a software-based room system for video conferencing.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of a conferencing system for delivering conferencing software services in an electronic computing and communications system.

FIG. 5 is a block diagram of an example of a software-based room system for conferencing software services.

FIG. 6 is a block diagram of an example of components of a physical conference space associated with a software-based room system.

FIG. 7 is a block diagram of an example of functionality of companion mode software usable with a software-based room system.

FIG. 8 is a block diagram of an example of video conference functionality accessible to companion mode devices via media channels.

FIG. 9 is a flow diagram of an example corresponding to asset claiming associated with a software-based room system for video conferencing.

FIG. 10 is a flow diagram of an example corresponding to asset claiming associated with a software-based room system for video conferencing.

FIGS. 11A-11D are diagrams of example user interfaces corresponding to asset claiming associated with a software-based room system for video conferencing.

FIG. 12 is a flowchart of an example of a technique for asset claiming associated with a software-based room system for video conferencing.

### DETAILED DESCRIPTION

Conferencing software is frequently used across various industries to support video-enabled conferences between participants in multiple locations. In some cases, each of the conference participants separately connects to the conferencing software from their own remote locations. In other cases, one or more of the conference participants may be physically located in and connect to the conferencing software from a conference room or similar physical conference space (e.g., in an office setting) while other conference participants connect to the conferencing software from one or more remote locations. Conferencing software thus enables people to conduct video conferences without requiring them to be physically present with one another. Conferencing software may be available as a standalone software product or it may be integrated within a software platform, such as a unified communications as a service (UCaaS) platform.

In some cases, a physical conference space may be equipped with a software-based room system to provide an integrated video conferencing experience for conference participants within the physical conference space. Conventional software-based room systems use a computing device, such as a desktop or laptop computer, to run software for configuring input and output devices (e.g., one or more cameras, microphones, and displays) of the physical conference space for use with video conferences. The computing device is also used to connect to server-side conferencing software that facilitates such video conferences to enable anyone in the physical conference space to participate in a video conference, for example, via the configured input and output devices. In a simple use case, a single camera, microphone, and display may be used in the physical conference space. In more complex use cases, multiple displays, microphones, and/or cameras may be used in the physical conference space.

Some existing conferencing approaches enable conference participants to utilize secondary computing devices in a companion mode designation during a video conference. Those devices, referred to interchangeably as companion mode devices or companion devices, are able to access certain functionality of the video conference upon connecting to the video conference in the typical manner (e.g., via a join request sent to a server implementing the video conference and server-side multimedia router (MMR) functionality enabling data communications with the joined device). In particular, a companion mode device, upon connecting to a video conference via such existing approaches, receives a companion mode designation and, with that, can begin streaming shared content, chat messages, or the like.

As video conferencing technology has advanced, the management of digital assets generated during these sessions has emerged as a challenge. These assets, which may include recordings, transcripts, shared files, and artificial intelligence (AI)-generated summaries, often lack a streamlined method for assigning ownership and access rights. Current video conferencing platforms frequently struggle with efficiently handling the distribution and ownership of meeting assets. The process of claiming and saving these assets often requires multiple manual steps, leading to inefficiencies and potential loss of valuable information. For instance, participants may need to separately request access to recordings, manually save shared files, and individually claim ownership of collaborative documents created during the session. This fragmented approach not only consumes time but also increases the risk of important assets being overlooked or improperly managed.

The complexity of asset management may be further compounded in shared physical conference spaces, such as conference rooms equipped with video conferencing systems. In these environments, multiple participants may be present, but the conferencing system may lack the capability to distinguish between them and assign asset ownership appropriately. This limitation can result in confusion regarding who has the right to access and distribute meeting assets, potentially leading to security concerns and inefficient post-meeting workflows. Additionally, the absence of a unified claiming mechanism can create bottlenecks in information dissemination, as participants must wait for manual distribution of assets by the meeting organizer or information technology (IT) administrators.

Moreover, the increasing integration of AI services in video conferencing systems, while beneficial for generating valuable meeting insights, introduces additional complexities in asset management. AI-generated summaries, action items, and other intelligent content lack a standardized method for automatic assignment to the appropriate participants. This gap in functionality can lead to underutilization of these advanced features, as users may struggle to efficiently access and leverage the AI-generated assets within their personal or organizational workflows.

Implementations of this disclosure address problems such as these by providing a unified system for claiming and saving meeting assets in a video conferencing environment. In some implementations, the system may output quick response (QR) code rendering data to cause a display device located within a physical conference space to present a QR code. The system may obtain, from a participant device located within the physical conference space, a click command indicative of a claiming request corresponding to a set of assets associated with the video conference. Based on the click command, the system may facilitate an ownership change operation to assign the set of assets to a participant account associated with the participant device.

As used herein, the term "physical conference space" refers to an indoor or outdoor location where one or more participants of a video conference may be physically present. For example, a physical conference space may be a conference room, an office, or a home workspace. The physical conference space may include various hardware components such as cameras, displays, and companion devices that enable participation in the video conference.

The term "participant device" refers to any computing device used by a conference participant to interact with the video conferencing system. This may include, but is not limited to, smartphones, tablets, laptops, or dedicated video conferencing hardware. In some implementations, a participant device may be designated as a companion device, allowing it to access video conference functionality without directly connecting to the conference.

"Meeting assets" refer to digital content generated during or associated with a video conference. These may include, but are not limited to, recordings of the conference, virtual meeting summaries, virtual whiteboards, chat logs, and AI-generated content such as action items or meeting transcripts. In some implementations, meeting assets may be stored on one or more asset servers, which manage access and ownership of these digital resources.

The system improves upon traditional video conferencing solutions by streamlining the process of claiming and managing meeting assets. By utilizing a QR code-based claiming mechanism, the system reduces the number of steps required for participants to take ownership of conference-related content. This technical advancement addresses the inefficiencies and potential loss of valuable information associated with manual asset distribution methods.

In some implementations, the system may determine a pairing between the participant device and a computing device located within the physical conference space. This pairing may be established using various technologies, such as Bluetooth, Wi-Fi, or ultrasonic signals. The pairing process enables secure communication between the devices and forms the basis for subsequent asset claiming operations.

The ownership change operation facilitated by the system may involve communicating with one or more asset servers to update access permissions and storage locations for the claimed assets. In some implementations, different types of assets may be managed by separate asset servers. For example, a first asset server may handle conference recordings, while a second asset server manages AI-generated meeting summaries. The system may provide separate ownership change requests to each relevant asset server to ensure comprehensive asset transfer.

In some implementations, the system may include additional features to enhance the asset claiming process. For instance, the system may assign host control of the video conference to the participant account that claims the assets, providing a seamless transition of meeting management responsibilities. The system may also support claiming of assets generated by AI services, such as automated transcriptions or sentiment analysis reports, ensuring that these advanced features are readily accessible to the appropriate participants.

In some examples of this disclosure, implementations may include or otherwise use one or more AI or ML (collectively, AI/ML) systems having one or more models trained for one or more purposes. Use or inclusion of such AI/ML systems, such as for implementation of certain features or functions, may be turned off by default, where a user, an organization, or both must opt-in to utilize the features or functions that include or otherwise use an AI/ML system. User or organizational consent to use the AI/ML systems or features may be provided in one or more ways, for example, as explicit permission granted by a user prior to using an AI/ML feature, as administrative consent configured by administrator settings, or both. Users for whom such consent is obtained can be notified that they will be interacting with one or more AI/ML systems or features, for example, by an electronic message (e.g., delivered via a chat or email service or presented within a client application or webpage) or by an on-screen prompt, which can be applied on a per-interaction basis. Those users can also be provided with an easy way to withdraw their user consent, for example, using a form or like element provided within a client application, webpage, or on-screen prompt to allow individual users to opt-out of use of the AI/ML systems or features.

To enhance privacy and safety, as well as provide other benefits, the AI/ML processing system may be prevented from using a user’s or organization’s personal information (e.g., audio, video, chat, screen-sharing, attachments, or other communications-like content (such as poll results, whiteboards, or reactions)) to train any AI/ML models and instead only use the personal information for inference operations of the AI/ML processing system. Instead of using the personal information to train AI/ML models, AI/ML models may be trained using one or more commercially licensed data sets that do not contain the personal information of the user or organization.

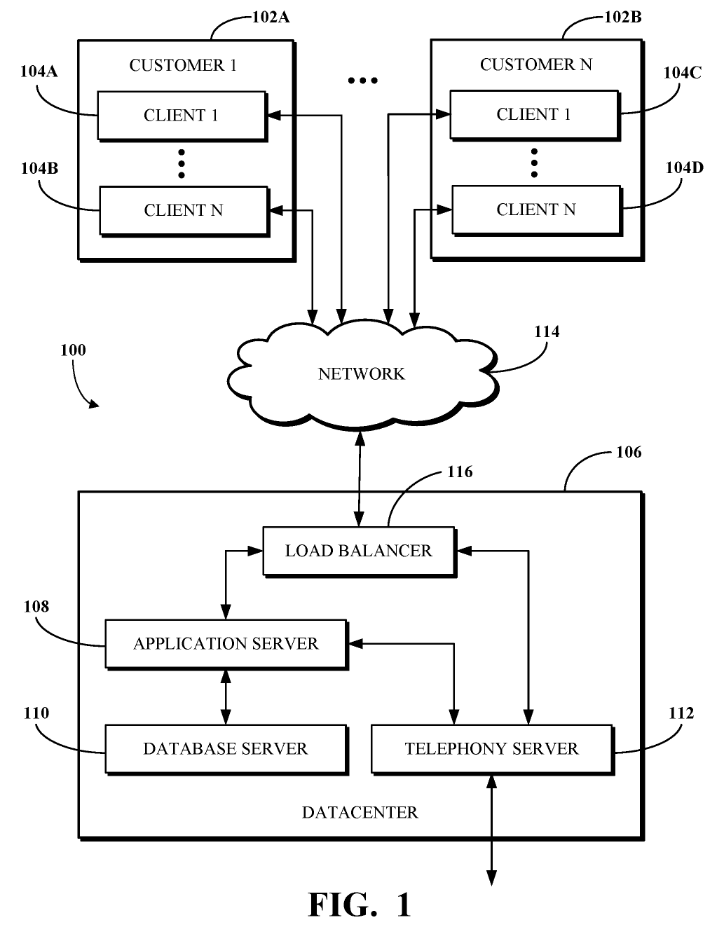

To describe some implementations in greater detail, reference is first made to examples of hardware and software structures used for asset claiming associated with a software-based room system for video conferencing. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, a client 104A, 104B, 104C, or 104D, or the application server 108.

The telephony server 112 enables network-based telephony and web communications from and/or to clients of a customer, such as the clients 104A through 104B for the customer 102A or the clients 104C through 104D for the customer 102B. For example, one or more of the clients 104A through 104D may be voice over internet protocol (VOIP)-enabled devices configured to send and receive calls over a network 114. The telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, a SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, a SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

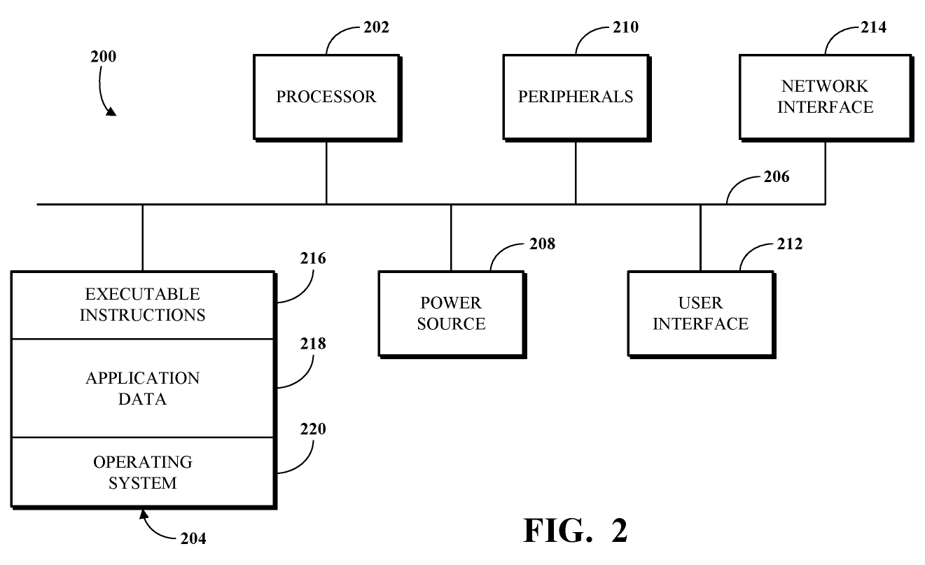

FIG. 2 is a block diagram of an example internal configuration of a computing device 200 of an electronic computing and communications system. In one configuration, the computing device 200 may implement one or more of the clients 104A, 104B, 104C and 104D, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

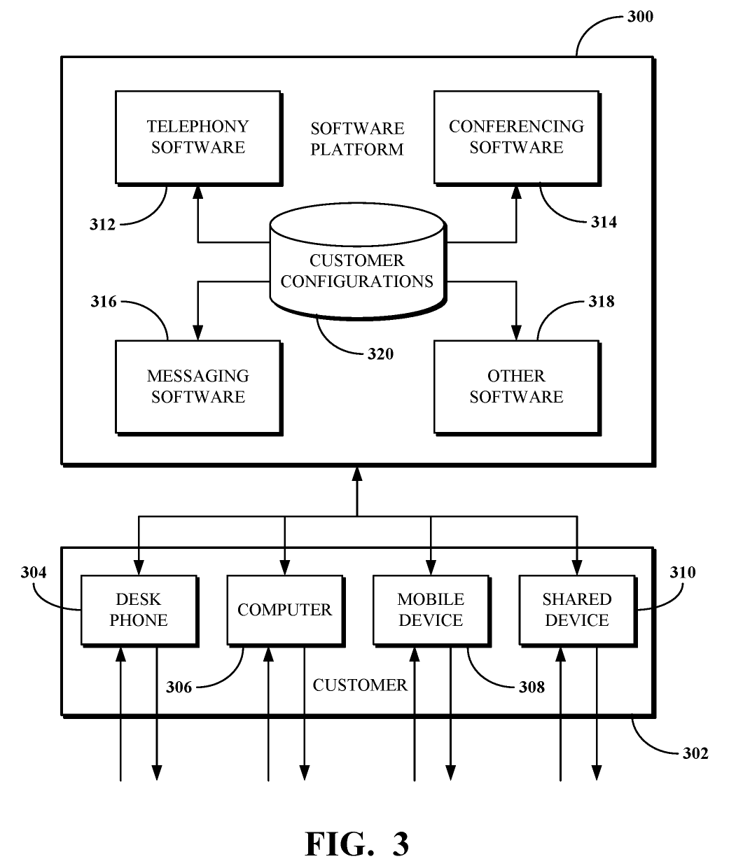

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients – a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

One or more of the desk phone 304, the computer 306, the mobile device 308, and the shared device 310 (the clients) includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between one or more of the desk phone 304, the computer 306, the mobile device 308, and the shared device 310 and other telephony-enabled devices, which may be other ones of the desk phone 304, the computer 306, the mobile device 308, and the shared device 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include companion mode software as disclosed herein and/or other software involved in facilitating asset claiming in video conferences for a software-based room system for conferencing software services. In some such cases, the conferencing software 314 can include the other software 318.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the desk phone 304, the computer 306, the mobile device 308, and the shared device 310.

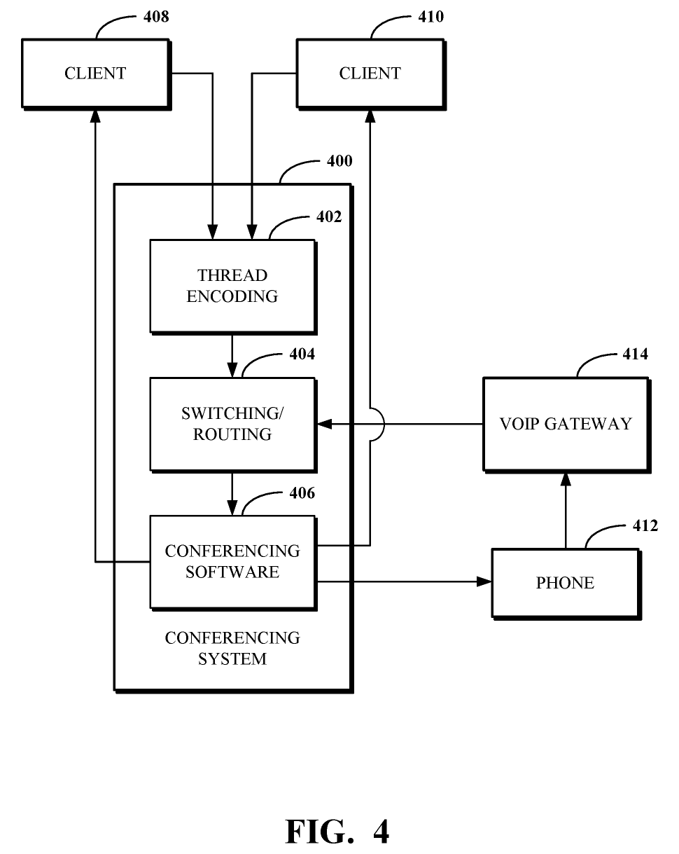

FIG. 4 is a block diagram of an example of a conferencing system 400 for delivering conferencing software services in an electronic computing and communications system, for example, the system 100 shown in FIG. 1. The conferencing system 400 includes a thread encoding tool 402, a switching/routing tool 404, and conferencing software 406. The conferencing software 406, which may, for example, the conferencing software 314 shown in FIG. 3, is software for implementing conferences (e.g., video conferences) between users of clients and/or phones, such as clients 408 and 410 and phone 412. For example, the clients 408 or 410 may each be one of the desk phone 304, the computer 306, the mobile device 308, or the shared device 310 shown in FIG. 3 that runs a client application associated with the conferencing software 406, and the phone 412 may be a telephone which does not run a client application associated with the conferencing software 406 or otherwise access a web application associated with the conferencing software 406. The conferencing system 400 may in at least some cases be implemented using one or more servers of the system 100, for example, the application server 108 shown in FIG. 1. Although two clients and a phone are shown in FIG. 4, other numbers of clients and/or other numbers of phones can connect to the conferencing system 400.

Implementing a conference includes transmitting and receiving video, audio, and/or other data between clients and/or phones, as applicable, of the conference participants. Each of the client 408, the client 410, and the phone 412 may connect through the conferencing system 400 using separate input streams to enable users thereof to participate in a conference together using the conferencing software 406. The various channels used for establishing connections between the clients 408 and 410 and the phone 412 may, for example, be based on the individual device capabilities of the clients 408 and 410 and the phone 412.

The conferencing software 406 includes a user interface tile for each input stream received and processed at the conferencing system 400. A user interface tile as used herein generally refers to a portion of a conferencing software user interface which displays information (e.g., a rendered video) associated with one or more conference participants. A user interface tile may, but need not, be generally rectangular. The size of a user interface tile may depend on one or more factors including the view style set for the conferencing software user interface at a given time and whether the one or more conference participants represented by the user interface tile are active speakers at a given time. The view style for the conferencing software user interface, which may be uniformly configured for all conference participants by a host of the subject conference or which may be individually configured by each conference participant, may be one of a gallery view in which all user interface tiles are similarly or identically sized and arranged in a generally grid layout or a speaker view in which one or more user interface tiles for active speakers are enlarged and arranged in a center position of the conferencing software user interface while the user interface tiles for other conference participants are reduced in size and arranged near an edge of the conferencing software user interface. In some cases, the view style or one or more other configurations related to the display of user interface tiles may be based on a type of video conference implemented using the conferencing software 406 (e.g., a participant-to-participant video conference, a contact center engagement video conference, or an online learning video conference, as will be described below).

The content of the user interface tile associated with a given participant may be dependent upon the source of the input stream for that participant. For example, where a participant accesses the conferencing software 406 from a client, such as the client 408 or 410, the user interface tile associated with that participant may include a video stream captured at the client and transmitted to the conferencing system 400, which is then transmitted from the conferencing system 400 to other clients for viewing by other participants (although the participant may optionally disable video features to suspend the video stream from being presented during some or all of the conference). In another example, where a participant access the conferencing software 406 from a phone, such as the phone 412, the user interface tile for the participant may be limited to a static image showing text (e.g., a name, telephone number, or other identifier associated with the participant or the phone 412) or other default background aspect since there is no video stream presented for that participant.

The thread encoding tool 402 receives video streams separately from the clients 408 and 410 and encodes those video streams using one or more transcoding tools, such as to produce variant streams at different resolutions. For example, a given video stream received from a client may be processed using multi-stream capabilities of the conferencing system 400 to result in multiple resolution versions of that video stream, including versions at 90p, 180p, 360p, 720p, and/or 1080p, amongst others. The video streams may be received from the clients over a network, for example, the network 114 shown in FIG. 1, or by a direct wired connection, such as using a universal serial bus (USB) connection or like coupling aspect. After the video streams are encoded, the switching/routing tool 404 direct the encoded streams through applicable network infrastructure and/or other hardware to deliver the encoded streams to the conferencing software 406. The conferencing software 406 transmits the encoded video streams to each connected client, such as the clients 408 and 410, which receive and decode the encoded video streams to output the video content thereof for display by video output components of the clients, such as within respective user interface tiles of a user interface of the conferencing software 406.

A user of the phone 412 participates in a conference using an audio-only connection and may be referred to an audio-only caller. To participate in the conference from the phone 412, an audio signal from the phone 412 is received and processed at a VOIP gateway 414 to prepare a digital telephony signal for processing at the conferencing system 400. The VOIP gateway 414 may be part of the system 100, for example, implemented at or in connection with a server of the datacenter 106, such as the telephony server 112 shown in FIG. 1. Alternatively, the VOIP gateway 414 may be located on the user-side, such as in a same location as the phone 412. The digital telephony signal is a packet switched signal transmitted to the switching/routing tool 404 for delivery to the conferencing software 406. The conferencing software 406 outputs an audio signal representing a combined audio capture for each participant of the conference for output by an audio output component of the phone 412. In some implementations, the VOIP gateway 414 may be omitted, for example, where the phone 412 is a VOIP-enabled phone.

A conference implemented using the conferencing software 406 may be referred to as a video conference in which video streaming is enabled for the conference participants thereof. The enabling of video streaming for a conference participant of a video conference does not require that the conference participant activate or otherwise use video functionality for participating in the video conference. For example, a conference may still be a video conference where none of the participants joining using clients turns on their video stream for any portion of the conference. In some cases, however, the conference may have video disabled, such as where each participant connects to the conference using a phone rather than a client, or where a host of the conference selectively configures the conference to exclude video functionality.

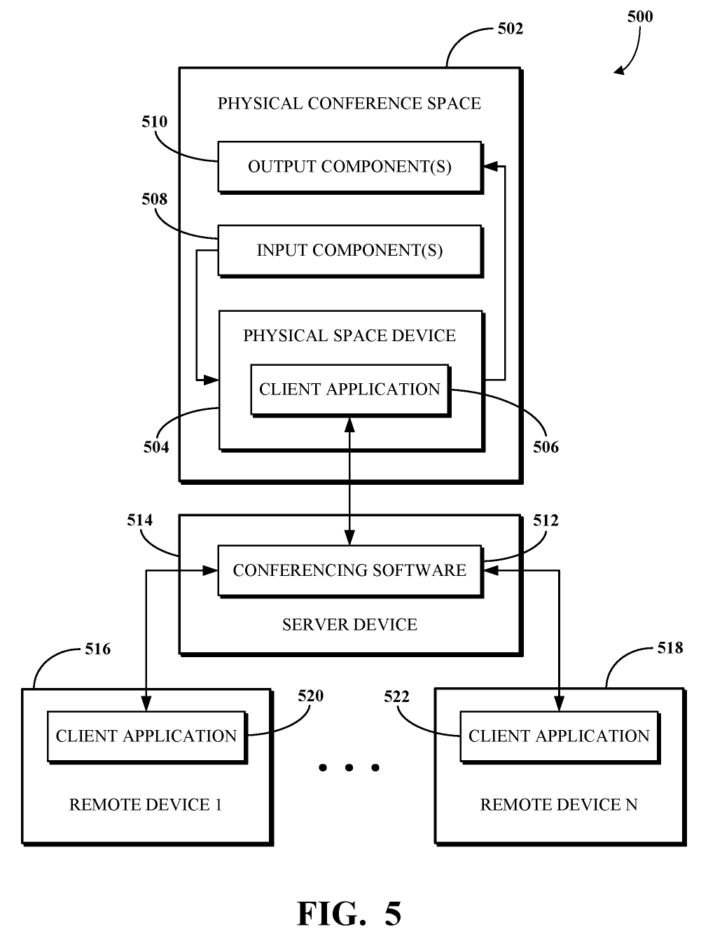

FIG. 5 is a block diagram of an example of a software-based room system 500 for conferencing software services, for example, the conferencing software services described with respect to FIGS. 3 and 4. The system 500 includes hardware and software components used to facilitate conferencing experiences within a physical conference space 502. The physical conference space 502 is an indoor or outdoor space within which one or more people may be physically located during some or all of a video conference. In one non-limiting example, the physical conference space 502 may be a conference room.

The physical conference space 502 includes a physical space device 504, which is a computing device that runs software including a client application 506 configured to connect the physical space device 504 to a video conference. For example, the physical space device 504 may be a client such as one of the desk phone 304, the computer 306, the mobile device 308, and the shared device 310 shown in FIG. 3 or one of the clients 408 through 410 shown in FIG. 4. While the physical space device 504 is shown as being located within the physical conference space 502, in some implementations, the physical space device 504 may instead be located external to but remain associated with the physical conference space 502. The physical conference space 502 also includes one or more input components 508 and one or more output components 510 usable in connection with a video conference. The one or more input components 508 may, for example, include one or more cameras, microphones, or sensors. The one or more output components 510 may, for example, include one or more displays.

The video conference which the client application 506 connects the physical space device 504 to is implemented by conferencing software 512 running at a server device 514, which may, for example, be a server used with the conferencing system 400 shown in FIG. 4. For example, the conferencing software 512 may be the conferencing software 314 shown in FIG. 3. The video conference is a video-enabled conference with two or more participants in which one or more of those participants are in the physical conference space 502 and one or more of those participants are remote participants located external to the physical conference space 502.

As shown, the remote participants connect the video conference via remote devices 1 516 through N 518, in which N is an integer greater than or equal to 2. Each of the remote devices 1 516 through N 518 is a computing device and may, for example, be one of the desk phone 304, the computer 306, the mobile device 308, and the shared device 310 or one of the clients 408 through 410. Where a single remote device is connected to the video conference, the remote device N 518 (as well as any other remote device other than the remote device 1 516) is omitted. As shown, each of the remote devices 1 516 through N 518 runs a client application 520 through 522, which are software configured to communicate with the conferencing software 512 to enable the users of the remote devices 1 516 through N 518 to participate in the video conference implemented using the conferencing software 512 as remote participants.

The one or more input components 508 capture input (e.g., video data) that is then transmitted to the conferencing software 512 for rendering within a user interface tile of a user interface of the video conference. For example, an input video stream from the physical space device 504 may be processed and output within a user interface tile associated with the physical conference space 502, and thus with the conference participants located thereat. Similarly, the remote devices 1 516 through N 518 each include one or more capture components, such as a camera, which capture input (e.g., video data) that is then transmitted to the conferencing software 512 for rendering within a user interface tile of a user interface of the video conference. For example, an input video stream from the remote device 1 516 may be processed and output within a user interface tile associated with the remote participant using the remote device 1 516 within the user interface of the video conference and an input video stream from the remote device N 518 may be processed and output within a user interface tile associated with the remote participant using the remote device N 518 within the user interface of the video conference.

In some implementations, one or more of the devices connected to the conferencing software 512 can connect to the video conference implemented by the conferencing software 512 other than by using a client application, such as the client applications 506 and 520 through 522. For example, the physical space device 504 and/or one or more of the remote devices 1 516 through N 518 may connect to the video conference using a web application running through a web browser. In another example, the physical space device 504 and/or one or more of the remote devices 1 516 through N 518 may connect to the video conference using a software application other than a web browser or a client application, for example, a non-client desktop or mobile application.

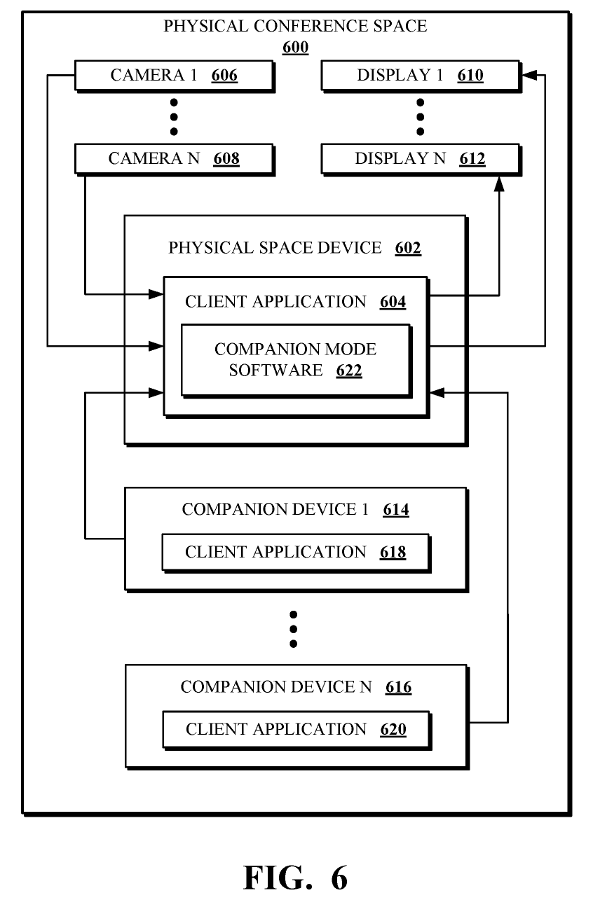

FIG. 6 is a block diagram of an example of components of a physical conference space 600 associated with a software-based room system, for example, the system 500 shown in FIG. 5. For example, the physical conference space 600 may be the physical conference space 502 shown in FIG. 5. The physical conference space 600 includes a physical space device 602, which is a computing device that runs a client application 604 configured to connect the physical space device 602 to a video conference to enable persons located at the physical conference space 600 to participate in the video conference. For example, the physical space device 602 and the client application 604 may respectively be the physical space device 504 and the client application 506 shown in FIG. 5.

The physical conference space 600 also includes hardware components usable with the physical space device 602 or otherwise in connection with a video conference to which the physical space device 602 may be connected via the client application 604. As shown, the physical conference space 600 includes cameras 1 606 through N 608, displays 1 610 through N 612, and companion devices 1 614 through N 616, in which the value of N in each case is an integer greater than or equal to 2. However: where the physical conference space 600 includes a single camera, the camera N 608 (as well as any other cameras other than the camera 1 606) is omitted; where the physical conference space 600 includes a single display, the display N 612 (as well as any other display other than the display 1 610) is omitted; and, where the physical conference space 600 includes a single companion device, the companion device N 616 (as well as any other companion devices other than the companion device 1 614) is omitted.

The cameras 1 606 through N 608 capture video data of the physical conference space 600 and transmit that video data as video streams for use with a video conference to the physical space device 602, which, via the client application 604, transmits those video streams to a server (e.g., the server device 514 shown in FIG. 5) to be processed and rendered within one or more user interface tiles of the video conference (e.g., via MMR functionality of the server). The cameras 1 606 through N 608 may, for example, correspond to the one or more input components 508 shown in FIG. 5. The cameras 1 606 through N 608 are connected to the physical space device 602 using one or more wired and/or wireless connections.

Each of the cameras 1 606 through N 608 has a field of view within the physical conference space 600 based on an angle and position thereof. For example, the camera 1 606 may be arranged on a first wall of the physical conference space 600 and have a field of view visible from that first wall while the camera N 608 may be arranged on a second wall of the physical conference space 600 perpendicular to the first wall and thus have a field of view that is different from that of the camera 1 606. Some or all of the cameras 1 606 through N 608 may be fixed such that their respective fields of view do not change. Alternatively, some or all of the cameras 1 606 through N 608 may have mechanical or electronic pan, tilt, and/or zoom functionality for narrowing, broadening, or changing the field of view thereof. For example, the pan, tilt, and/or zoom functionality of a camera may be electronically controlled, such as by a device operator or by a software intelligence aspect, such as a machine learning (ML) model or software which uses a ML model for field of view adjustment.

The displays 1 610 through N 612 output media of the video conference (e.g., participant video streams, screen share data, chat messages, user interface elements, whiteboards, participant lists, and the like), received via the client application 604, for viewing by conference participants who are located at the physical conference space 600. The displays 1 610 through N 612 may, for example, correspond to the one or more output components 510 shown in FIG. 5. The displays 1 610 through N 612 are connected to the physical space device 602 using one or more wired and/or wireless connections.

The displays 1 610 through N 612 may have the same or different media output functionality. For example, in some cases, all of the displays 1 610 through N 612 may have the same video refresh rate, resolution, input capture, and related capabilities. In other cases, however, one or more of the displays 1 610 through N 612 may have capabilities that differ from those of others of the displays 1 610 through N 612. For example, the display 1 610 may have a touch screen interface capable of receiving touch input to manipulate content output thereat while the display N 612 may lack such a touch screen interface. Ones of the displays 1 610 through N 612 may be located next to, nearby, or away from one another within the physical conference space 600. For example, the display 1 610 may be located on a first wall of the physical conference space 600 while the display N 612 may be located on a second wall thereof.

The companion devices 1 614 through N 616 are computing devices (e.g., tablet computers, laptop computers, digital whiteboard displays, or the like) located within the physical conference space 600 and usable with a video conference without connecting to the video conference. The companion devices 1 614 through N 616 run client applications 618 through 620, respectively, which facilitate the pairing of the companion devices 1 614 through N 616 with the physical space device 602 and, based on such pairing, enable access to functionality of the video conference at the companion devices 1 614 through N 616. In particular, the companion devices 1 614 through N 616, upon pairing with the physical space device 602 and the physical space device 602 being connected to a video conference, may be used to access functionality of the video conference via the client applications 618 through 620, respectively. Because the companion devices 1 614 through N 616 are used by participants of a video conference, they may be referred to as participant devices. For example, a participant device may be designated in a companion device mode to be recognized as a companion device.

Some or all of the companion devices 1 614 through N 616 may include one or more input components (e.g., cameras, microphones, or other sensors) configured to capture input usable with the video conference and one or more output components (e.g., displays or speakers) configured to output media associated with the video conference. Thus, in at least some cases, the companion devices 1 614 through N 616 may, for example, correspond to both of the one or more input components 508 and the one or more output components 510 shown in FIG. 5.Non-limiting examples of video conference functionality accessible to the companion devices 1 614 through N 616 in this way may thus include receiving and outputting for display participant video streams captured at other devices (e.g., the physical space device 602 and/or one or more remote participant devices, such as the remote devices 1 516 through N 518 shown in FIG. 5), receiving and outputting audio captured at other devices, receiving and outputting for display media shared to the video conference by another device, capturing audio and/or video media and communicating same for use in the video conference, participating in chat messaging with other participants of the video conference, or transmitting media for sharing to the video conference.

The companion devices 1 614 through N 616 may be physically coupled to furniture or other physical aspects within the physical conference space 600. For example, some or all of the companion devices 1 614 through N 616 may be affixed (e.g., via mounting, docks, fasteners, or the like) to areas of a conference room table. For example, a conference room table may have a companion device located in front of each seat such that anyone who sits in any seat of the conference room, as the physical conference space 600, may have access to a companion device. In some such cases, however, the companion devices may be limited to only certain seats around the conference room table.

Alternatively, the companion devices 1 614 through N 616 may be entirely mobile and thus movable by users thereof without needing to remove the companion devices 1 614 through N 616 from units or otherwise deform any coupling mechanisms which may otherwise be used to affix the companion devices 1 614 through N 616 about the physical conference space 600. For example, the companion devices 1 614 through 616 may be made available to conference participants via a physical storage accessible within or nearby the physical conference space 600, and participants may accordingly bring a companion device to their seat for use during a video conference, as instructed or desired. In another example, the companion devices 1 614 through 616 may be personal computing devices of the users thereof and thus may be brought into the physical conference space 600 by those users for use with a video conference.

The client application 604 running at the physical space device 602 includes companion mode software 622 that enables the use of the companion devices 1 614 through N 616 with a video conference to which the physical space device 602 is connected by implementing and using a media channel for the companion devices 1 614 through N 616 to use to communicate with the physical space device 602 without the companion devices 1 614 through N 616 themselves connecting to the video conference. In particular, the companion mode software 622 is configured to determine a pairing between a companion device (i.e., as one of the companion devices) 1 614 through N 616 and the physical space device 602 and, based on that pairing, instantiate a media channel enabling communications of media of the video conference between the companion device and the physical space device 602 during the video conference. The companion mode software 622 may, for example, determine pairings with and instantiate media channels for each individual one of the companion devices 1 614 through N 616 which will be used with the video conference.

The media channel instantiated between the companion device, as a participant device, and the physical space device 602, as a computing device, is used to facilitate the communications of video conference media between that participant device and that computing device during the video conference independent of a connection of the participant device to the video conference (i.e., without the participant device connecting to the video conference). In particular, video conference media is obtained at the computing device from the server implementing the video conference, and the computing device, using the companion mode software 622, communicates that obtained video conference media to the participant device via the media channel. Similarly, media captured at the participant device is obtained at the computing device via the media channel, using the companion mode software 622, and then communicated from the computing device to the server implementing the video conference to cause that media to be included in the video conference (e.g., as a participant video stream which may be rendered at devices connected to the video conference).

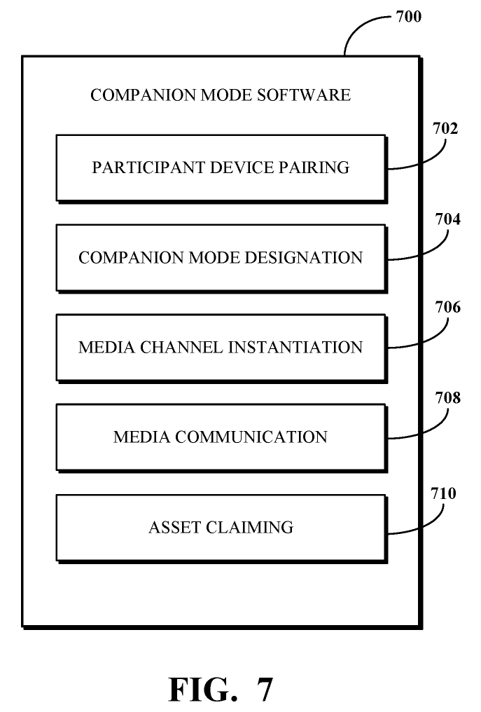

FIG. 7 is a block diagram of an example of functionality of companion mode software 700 usable with a software-based room system, for example, the system 500 shown in FIG. 5. The companion mode software 700 may, for example, be the companion mode software 622 shown in FIG. 6. The companion mode software 700 includes tools, such as programs, subprograms, functions, routines, subroutines, operations, and/or the like, for implementing and using a media channel for companion mode devices paired with a software-based room system for video conferencing and for claiming assets of a video conference. As shown, the companion mode software 700 includes a participant device pairing tool 702, a companion mode designation tool 704, a media channel instantiation tool 706, a media communication tool 708, and an asset claiming tool 710.

The participant device pairing tool 702 determines a pairing between a computing device located within a physical conference space (e.g., the physical space device 602 located within the physical conference space 600 shown in FIG. 6) and connected to a video conference and a participant device located within the physical conference space (e.g., one of the companion devices 1 614 through N 616 shown in FIG. 6). The pairing between the computing device and the participant device represents a wireless connection between those devices over one or more protocols. For example, the pairing may be performed via a short range communication protocol, such as Bluetooth, or using an ultrasonic frequency. With Bluetooth or similar short range communication protocols, the participant device pairing tool 702 may receive a pairing request from the participant device and determine the pairing based on that pairing request. For example, the pairing request may identify the participant device and a shared connection key usable (e.g., by the participant device pairing tool 702) to establish a pairing with the participant device. With ultrasonic pairing, the computing device, via the participant device pairing tool 702 or otherwise, emits (e.g., broadcasts) an ultrasonic frequency which may be recognized using a client application running at the participant device. In response to the ultrasonic frequency, the participant device, via the client application running thereat, transmits a signal including a request to pair with the computing device. The participant device pairing tool 702 may thus determine a pairing between the participant device and the computing device based on an acceptable of that request. In some cases, due to the nature of ultrasonic pairing, the pairing may only be possible while the participant device is located within the same physical conference space as the computing device.

The companion mode designation tool 704 designates the participant device in a companion mode based on the pairing determined between the computing device and the participant device. The designation of the participant device in the companion mode, thus identifying the participant device as a companion mode device, represents an identification of the participant device as a device which will not connect to the video conference but which will notwithstanding still be used with the video conference. For example, the companion mode designation tool 704 may designate the participant device in the companion mode based on the pairing by determining, in response to or otherwise sometime after the pairing is determined, that the device will be used with the video conference but not be connected to the video conference. In some such cases, the companion mode designation tool 704 may, based on the determined pairing, cause a prompt to be output for display at the participant device in which the prompt asks a user of the participant device for input indicating whether to use the participant device as a companion mode device. In such a case, the companion mode designation is based on the input received based on the prompt. In other such cases, the companion mode designation tool 704 may determine to designate the participant device in the companion mode independent of user input. For example, the companion mode designation tool 704 may access and leverage records indicative of historical use of the participant device with one or more past conferences to determine a past companion mode designation of the participant device. In another example, the companion mode designation tool 704 may use other logic to automate the designation of the participant device in the companion mode. In some such cases, the companion mode designation tool 704 may automatically designate, in the companion mode, participant devices paired to the computing device and not connected to the video conference as the computing device.

The media channel instantiation tool 706 instantiates a media channel between the computing device and the participant device based on the companion mode designation of the participant device (and thus based on the pairing determined between the computing device and the participant device). The media channel is a two-way mechanism enabling the passage of data (e.g., video conference media) between the computing device and the participant device based on the computing device and the participant device being paired, the participant device being recognized (e.g. designated) in the companion mode, and the computing device being connected to the video conference while the participant device is not connected thereto. For example, the media channel may be a logical grouping of software packages enabling a direct or indirect communication of synchronous and/or asynchronous media content data between the computing device and the participant device over a subscription by the client running at the participant device to the client running at the computing device. In such a case, instantiating the media channel includes the media channel instantiation tool 706 establishing a subscription of the participant device to the computing device in a manner that configures the client running at the participant device to communicate media data with the client running at the computing device. In another example, the media channel may be a logical link between the computing device and the participant device enabling the passing of messages representing synchronous and/or asynchronous media content data. In such a case, instantiating the media channel includes configuring the computing device to receive messages from the participant device and configuring the participant device to receive messages from the computing device.

The media communication tool 708 facilitates communications of media of the video conference between the computing device and the participant device via the media channel, independent of a connection of the participant device to the video conference. In particular, the media communication tool 708 enables access to functionality of the video conference at the participant device via the media channel. Thus, the facilitation of communications of media by the media communication tool 708 may include media captured at the participant device being communicated to the computing device for processing and ultimately for communication to the server implementing the video conference, media captured at a device other than the participant device being communicated from the computing device (e.g., as obtained via the server) to the participant device, or the like.

The asset claiming tool 710 may be configured to facilitate an ownership change operation to assign a set of assets associated with the video conference to a participant account. In some implementations, the asset claiming tool 710 may output QR code rendering data to cause a display device located within the physical conference space to present a QR code. The asset claiming tool 710 may obtain, from a participant device located within the physical conference space, a click command indicative of a claiming request corresponding to the set of assets associated with the video conference. Based on the click command, the asset claiming tool 710 may facilitate the ownership change operation.

In some implementations, the asset claiming tool 710 may determine a pairing between the participant device and the computing device. The asset claiming tool 710 may output, to the participant device, confirmation rendering data to cause the participant device to present an interactive user interface (UI) element. The click command may be based on a user interaction with the interactive user interface element. To facilitate the ownership change operation, the asset claiming tool 710 may provide, to an asset server associated with the set of assets, an ownership change request. The asset claiming tool 710 may output notification rendering data to cause the participant device or the display device to present a notification indicative of completion of the ownership change operation.

The set of assets may include at least one of a recording associated with the video conference, a virtual meeting summary associated with the video conference, or a virtual meeting whiteboard associated with the video conference. In some implementations, the set of assets may include a set of content generated by an AI service including at least one ML model. The asset claiming tool 710 may assign, based on the ownership change operation, host control of the video conference or a set of permissions associated with the video conference to the participant account. In some implementations, where the set of assets includes a first asset and a second asset, the asset claiming tool 710 may provide a first ownership change request to a first asset server associated with the first asset and provide a second ownership change request to a second asset server associated with the second asset.

Although the tools 702 through 710 are shown as separate tools, in some implementations, two or more of the tools 702 through 710 may be combined into a single tool. Although the tools 702 through 710 are shown as functionality of the companion mode software 700 as a single piece of software, in some implementations, some or all of the tools 702 through 710 may exist outside of the companion mode software 700, or the companion mode software 700 may be implemented as multiple software aspects running at the same or different computing devices. In some such implementations, one or more of the tools 702 through 710 may be run as software at a physical space device (e.g., the physical space device 602 shown in FIG. 6) while others of the tools 702 through 710 may be run as software at a server (e.g., the server device 514 shown in FIG. 5).

In some implementations, the companion mode software 700 may include one or more tools in addition to, or in place of one or more of, the tools 702 through 710. For example, the companion mode software 700 may include a media channel termination tool that terminates a media channel instantiated by the media channel instantiation tool 706 and used by the media communication tool 708. In particular, the media channel termination tool may be configured to terminate the media channel upon an end of the video conference (i.e., in response to a host of the video conference indicating to end the video conference), an unpairing between the participant device and the computing device, a disconnection of the computing device from the video conference, and/or the participant device ceasing to be designated in the companion mode (e.g., due to the participant device connecting to the video conference). In some such cases, the media channel termination tool may cause the termination of the media channel at a first to occur of a set of conditions including, without limitation, the foregoing.

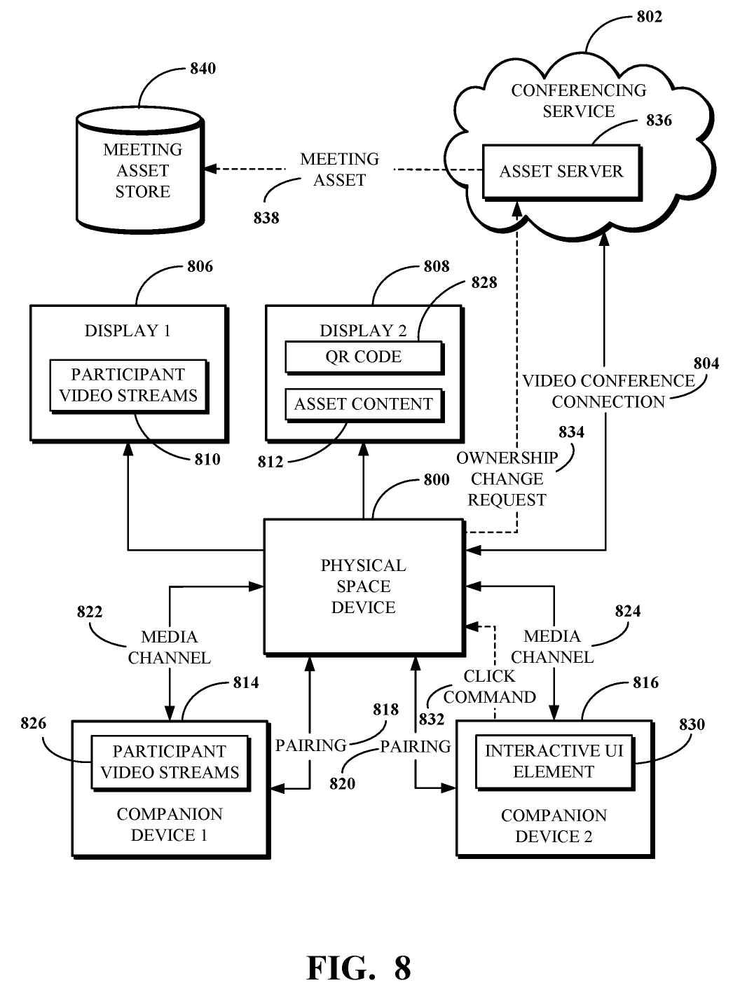

FIG. 8 is a block diagram of an example of video conference functionality accessible to companion mode devices via media channels. A physical space device 800, which may, for example, be the physical space device 602 shown in FIG. 6, connects to a video conference implemented via a server 802, which may, for example, be the server device 514 shown in FIG. 5, resulting in a video conference connection 804 for the physical space device 800. For example, the server 802 may include MMR functionality for connecting devices to and implementing a video conference. While a single server 802 is shown, in some cases, multiple servers may be involved.

In the example shown, and while not limited to a particular number of displays, the physical space device 800 outputs media to two different displays of a physical conference space, including a display 1 806 and a display 2 808, each of which may be one of the displays 1 610 through N 612 shown in FIG. 6. In particular, participant video streams 810 are output at the display 1 806 and asset content 812 is output at the display 2 808. For example, the participant video streams 810 may include one or more video streams of the physical conference space that includes the physical space device 800 (e.g., captured using one or more cameras, such as the cameras 1 606 through N 608 shown in FIG. 6) and/or one or more video streams captured at other participant devices (e.g., the remote devices 1 516 through N 518 shown in FIG. 5), and the asset content 812 may include shared content such as media shared to the video conference by a device connected to the video conference.

In the example shown, and while not limited to a particular number of companion devices, two companion devices, including a companion device 1 814 and a companion device 2 816, are used with the physical space device 800 for the video conference. For example, the companion devices 1 814 and 2 816 may be the companion devices 1 614 through N 616 shown in FIG. 6. Each of the companion devices 1 814 and 2 816 is a participant device that is both not connected to the video conference to which the physical space device 800 is connected and paired to the physical space device 800. For example, the companion device 1 814 may be paired with the physical space device 800 to result in a pairing 818, and the companion device 2 816 may be paired with the physical space device 800 to result in a pairing 820. The pairing 818 and the pairing 820 each represent separate logical connections involving, with the pairing 818 being between the physical space device 800 and the companion device 1 814 and the pairing 820 being between the physical space device 800 and the companion device 2 816. In some cases, the pairing 818 and the pairing 820 may be by way of a same protocol or other manner, for example, both as Bluetooth connections or both via ultrasonic pairing. In other cases, the pairing 818 and the pairing 820 may be different, for example, with one by Bluetooth and the other by ultrasonic.

Based on the pairing 818, a media channel 822 is instantiated between the physical space device 800 and the companion device 1 814 to enable communications of video conference media between the physical space device 800 and the companion device 1 814. Similarly, based on the pairing 820, a media channel 824 is instantiated between the physical space device 800 and the companion device 2 816 to enable communications of video conference media between the physical space device 800 and the companion device 2 816. In particular, as shown, via the media channel 822, participant video streams 826 may be communicated from the physical space device 800 to the companion device 1 814 for output at a display of the companion device 1 814. For example, the participant video streams 826 may be the same as the participant video streams 810 or may be different therefrom (e.g., the participant video streams 826 may include video streams captured at devices other than the physical space device 800). For example, the participant video streams 826 may be the same as the participant video streams 810 or may be different therefrom (e.g., the participant video streams 826 may include video streams captured at devices other than the physical space device 800). In some implementations, via the media channel 824, shared content may be communicated from the physical space device 800 to the companion device 2 816 for output at a display of the companion device 2 816. For example, the shared content may be the same as the asset content 812 or may be different therefrom.

While not shown, the companion devices 1 814 and 2 816 may each include one or more media capture components (e.g., cameras, microphones, or the like) for capturing media to communicate for inclusion in the video conference. In such a case, the media channel 822 may be used to communicate media captured at the companion device 1 814 to the physical space device 800, in which the physical space device 800 may thus communicate the media obtained from the companion device 1 814 via the media channel 822 in its original form or in a processed form to the server 802 for inclusion within the video conference and thus for communication to and eventual output at other devices connected to the video conference. Similarly, the media channel 824 may be used to communicate media captured at the companion device 2 816 to the physical space device 800, in which the physical space device 800 may thus communicate the media obtained from the companion device 2 816 via the media channel 824 in its original form or in a processed form to the server 802 for inclusion within the video conference and thus for communication to and eventual output at other devices connected to the video conference.

In some implementations, the physical space device 800 may be configured to facilitate asset claiming functionality associated with the video conference. The physical space device 800 may output QR code rendering data to cause a display device located within the physical conference space, such as display 2 808, to present a QR code 828. The QR code 828 may be associated with a set of assets related to the video conference.

In some implementations, scanning the QR code at the participant device may initiate a series of steps leading to the presentation of the interactive UI element and subsequent transmission of the click command. When a user scans the QR code 828 using the participant device, such as companion device 2 816, the participant device may decode the information embedded in the QR code. This decoded information may include a unique identifier for the video conference and potentially a secure token or key.

Upon decoding the QR code, the participant device may send a request to the physical space device 800 or directly to the server 802, including the decoded information. This request may serve to authenticate the participant device and associate it with the specific video conference.

After successful authentication, the physical space device 800 or server 802 may send confirmation rendering data to the participant device. This data may instruct the client application running on the participant device to present the interactive UI element 830. The interactive UI element 830 may take the form of a button or dialog box prompting the user to confirm their intention to claim and save the meeting assets.

When the user interacts with the presented UI element, such as by tapping a "Claim and Save" button, the participant device generates the click command 832. This click command 832 may include information about the user's account, the specific assets being claimed, and any other relevant metadata.

The click command 832 is transmitted from the participant device to the physical space device 800. In some cases, this transmission may occur through the established media channel 824, leveraging the existing pairing 820 between the devices. In other cases, the click command 832 may be sent directly to the server 802 if the participant device has established a separate connection to the video conference system. In some implementations, the interactive UI element 830 may be displayed based on (e.g., in response to) a pairing between the companion device 2 816 and the physical space device 800. For example, the physical space device 800 may determine a pairing between the companion device 2 816 and the physical space device 800. The physical space device 800 may output, to the companion device 2 816, confirmation rendering data to cause the companion device 2 816 to present the interactive UI element 830. The click command 832 may be based on a user interaction with the interactive UI element 830 presented on the companion device 2 816.

By structuring the asset claiming process in this manner, the system may provide a seamless and secure method for users to claim meeting assets using their personal devices, while maintaining the integrity of the video conference environment.

The click command 832 may be indicative of a claiming request corresponding to the set of assets associated with the video conference. Based on the click command 832, the physical space device 800 may facilitate an ownership change operation to assign the set of assets to a participant account associated with the companion device 2 816. In some implementations, facilitating the ownership change operation may include providing an ownership change request 834 to an asset server 836 associated with the set of assets. The asset server 836 may be configured to manage access and ownership of meeting assets 838 associated with the video conference.

The asset server 836 may be a dedicated server or a component within the video conferencing system that specializes in managing, storing, and controlling access to various types of meeting assets. These assets may include, but are not limited to, recordings of the video conference, transcripts, shared files, virtual whiteboards, and AI-generated summaries or action items. The asset server 836 may maintain a database or other data structure to track ownership, permissions, and metadata associated with each asset, facilitating access to, or modification of, the assets by only authorized users.

In some implementations, the system may utilize multiple asset servers, each potentially dedicated to handling specific types of meeting assets or serving different geographical regions. For example, one asset server may be responsible for managing video recordings, while another may focus on text-based assets such as transcripts and chat logs. This distributed approach may enhance system performance, improve scalability, and allow for more efficient data management. In cases where multiple asset servers are employed, the physical space device 800 or the server 802 may coordinate with these various asset servers to ensure comprehensive asset management across all types of meeting content.

Where the set of assets includes a first asset and a second asset, the physical space device 800 may provide a first ownership change request to a first asset server associated with the first asset and provide a second ownership change request to a second asset server associated with the second asset. This approach may allow for granular control and management of different types of meeting assets across multiple asset servers.

The use of multiple asset servers may also provide additional benefits in terms of redundancy and data security. By distributing assets across different servers, the system may reduce the risk of data loss due to server failures and may allow for region-specific data storage to comply with various data protection regulations. In some cases, the asset servers may employ load balancing techniques to optimize resource utilization and ensure rapid access to meeting assets, even during periods of high demand. The flexibility of this multi-server architecture may allow the video conferencing system to adapt to evolving needs and scale efficiently as the volume of meeting assets grows over time.

The set of assets may include at least one of a recording associated with the video conference, a virtual meeting summary associated with the video conference, or a virtual meeting whiteboard associated with the video conference. In some implementations, the set of assets may include a set of content generated by an AI service including at least one ML model.

An ML component refers to hardware and/or software capable of performing ML. ML is a subset of AI that involves the development of algorithms and statistical models enabling computers to perform tasks without explicit programming. ML leverages large datasets to identify patterns, make decisions, and improve over time based on experience. ML focuses on creating systems that can learn from data, adapt to new inputs, and generate predictions or actions.

For example, an ML component may be or include one or more ML models, ML algorithms, and/or ML systems including combinations of ML algorithms and ML models. An ML component may be implemented on any number of different hardware devices and may include one or more ML models. ML is a field of study that gives computers the ability to perform certain tasks without being explicitly programmed to perform those tasks. In traditional computing, a programmer would encode instructions (e.g., to solve a quadratic equation using the quadratic formula), and the computer would perform those exact instructions. In contrast, in ML, a computer can be provided with examples and be trained to perform a task such as prediction or classification, without the programmer encoding explicit instructions for the task. ML explores the study and construction of algorithms, also referred to herein as tools, models, and/or components, which may learn from existing data and make predictions about new data. Such ML tools operate by building a model from example training data in order to make data-driven predictions or decisions expressed as outputs or assessments. Although example embodiments are presented with respect to a few ML models, the principles presented herein may be applied to other ML models. In some example embodiments, different ML models may be used. ML models may include, for example, K-means clustering models, linear regression models, logistic regression (LR) models, Naive-Bayes models, random forest (RF) regression models, gradient boost models, neural networks (NN), matrix factorization models, large language models (LLMs), and/or support vector machines (SVMs), among other examples.

The meeting assets 838 may be stored in the meeting asset store 840, which may be accessed and updated by the asset server 836 in response to ownership change operations. The physical space device 800 may be configured to output notification rendering data to cause the companion device 2 816 or the display device (e.g., display 2 808) to present a notification indicative of completion of the ownership change operation. This notification may provide visual confirmation to the user that the set of assets has been successfully assigned to their participant account.

In some implementations, based on the ownership change operation, the physical space device 800 may assign host control of the video conference to the participant account associated with the companion device 2 816. In some implementations, the physical space device 800 may assign a set of permissions associated with the video conference to the participant account based on the ownership change operation.

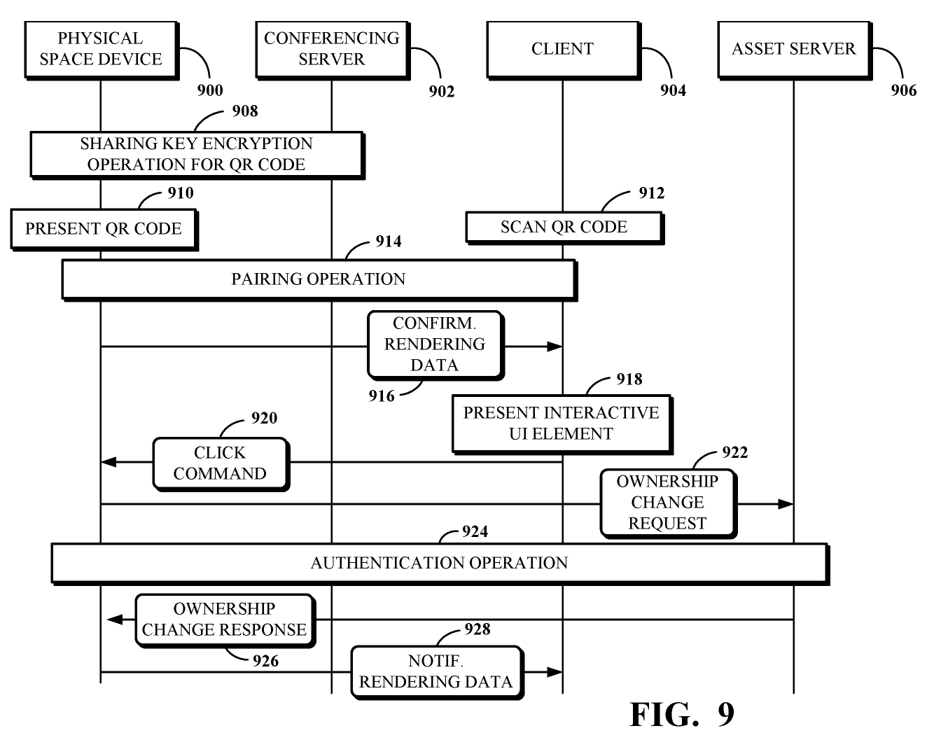

FIG. 9 is a flow diagram of an example corresponding to asset claiming associated with a software-based room system for video conferencing. The flow diagram illustrates interactions between a physical space device 900, a conferencing server 902, a client 904, and an asset server 906.

In some implementations, at operation 908, the physical space device 900 and the conferencing server 902 may perform a sharing key encryption operation to generate the QR code. This operation may involve the physical space device 900 transmitting an encryption request to the conferencing server 902, which may create a unique sharing key associated with the video conference and the set of assets to be claimed. The sharing key may include information such as a conference identifier, asset identifiers, and a timestamp.

The conferencing server 902 may encrypt this sharing key using a cryptographic algorithm, which may enhance security by preventing unauthorized access to the conference assets. The encryption process may utilize various techniques such as symmetric key encryption, public key encryption, or a combination of both.

Once the sharing key is encrypted, the physical space device 900 or the conferencing server 902 may encode the encrypted data into a QR code format. This QR code may contain the encrypted sharing key along with any additional metadata required for the claiming process. The resulting QR code may be designed to be easily scannable by participant devices while maintaining the security of the encoded information.

In some implementations, the sharing key encryption operation 908 may also involve generating a corresponding decryption key or method that will be used later in the process to verify the legitimacy of the claiming request. This decryption mechanism may be securely stored by the physical space device 900 or shared with the conferencing server 902 for later use in the authentication process.

The encrypted QR code generated in this operation serves as a secure and efficient means of initiating the asset claiming process, allowing authorized participants to easily request ownership of meeting assets while maintaining the integrity and confidentiality of the video conference environment.

At operation 910, the physical space device 900 may present the QR code. The physical space device 900 may present the QR code on a display device located within the physical conference space. This display device may be a dedicated screen, a large format display, or an integrated display component of the physical space device 900 itself. In some implementations, the QR code may be prominently displayed to ensure visibility to all participants in the room. The physical space device 900 may adjust the size, resolution, or contrast of the QR code to facilitate readability across various lighting conditions and viewing distances within the physical conference space.

In some cases, the physical space device 900 may present the QR code alongside contextual information, such as instructions for scanning or a brief explanation of the asset claiming process. The QR code presentation may be timed to coincide with specific events during the video conference, such as when the client 904 (e.g., participant device running a client application) is detected in the physical conference space, at the beginning of the meeting, or when a participant initiates an asset claiming request.

The physical space device 900 may also implement dynamic QR code presentation techniques. For instance, the QR code may be periodically refreshed or rotated to enhance security. In some implementations, the physical space device 900 may present multiple QR codes simultaneously, each corresponding to different sets of assets or access levels, allowing for more granular control over asset distribution.

At operation 912, the client 904, which may be a participant device located within the physical conference space, scans the QR code presented on the display. In some implementations, this scanning process may initiate a pairing operation 914 between the client 904 and the physical space device 900. This pairing may be established using various technologies, such as Bluetooth, Wi-Fi, or ultrasonic signals. The pairing operation 914 may enable secure communication between the devices and form the basis for subsequent asset claiming operations.

In some implementations, after the pairing is established, the physical space device 900 may output confirmation rendering data to the client 904 at operation 916. This confirmation rendering data may cause the client 904 to present, at operation 918, an interactive user interface element, such as a button or dialog box, prompting the user to confirm their intention to claim and save the meeting assets.

The client 904 may obtain a user interaction with the interactive user interface element. Based on this user interaction, at operation 920, the client 904 transmits a click command to the physical space device 900. This click command may be indicative of a claiming request corresponding to the set of assets associated with the video conference. In some implementations, this transmission may occur through an established media channel or control channel, leveraging the existing pairing between the devices. In some implementations, the click command may be sent directly to the conferencing server 902 if the client 904 has established a separate connection to the video conferencing system.

Upon receiving the click command, the physical space device 900 facilitates an ownership change operation to assign the set of assets to a participant account associated with the client 904. This facilitation may involve providing an ownership change request to the asset server 906 at operation 922. The asset server 906 may be configured to manage access and ownership of meeting assets associated with the video conference.

In some implementations, where the set of assets includes a first asset and a second asset, the physical space device 900 may provide a first ownership change request to a first asset server associated with the first asset and provide a second ownership change request to a second asset server associated with the second asset. This approach may allow for granular control and management of different types of meeting assets across multiple asset servers.

At operation 924, the asset server 906 performs an authentication operation to verify the claiming request and the associated participant account. This authentication process may involve checking the user's credentials, verifying their permissions within the video conferencing system, and ensuring that the requested assets are available for claiming. For example, the asset server 906 may communicate with the conferencing server 902 or another server to authenticate the user.

Following successful authentication, the asset server 906 may execute the ownership change operation and may send an ownership change response back to the physical space device 900 at operation 926. This response may confirm the successful transfer of ownership and provide any relevant details about the newly assigned assets. The ownership change operation may involve updating access permissions, modifying metadata associated with the assets, or transferring the assets to a storage location associated with the participant account.

At operation 928, the physical space device 900 may output notification rendering data. This data may cause the client 904 or the display device 900 within the physical conference space to present a notification indicative of the completion of the ownership change operation. This notification may provide visual confirmation to the user that the set of assets has been successfully assigned to their participant account.

In some implementations, based on the ownership change operation, the physical space device 900 may assign host control of the video conference to the participant account associated with the client 904. In some implementations, the physical space device 900 may assign a set of permissions associated with the video conference to the participant account based on the ownership change operation. These permissions may include the ability to access, edit, or share the claimed assets, as well as other conference-related privileges.

The flow diagram illustrated in FIG. 9 may be implemented using various hardware and software components. For example, the physical space device 900 and the client 904 may each include one or more processors configured to execute instructions stored in one or more memories to perform the operations described. Similarly, the conferencing server 902 and the asset server 906 may include one or more processors and memories configured to manage the video conference and associated assets.

In some implementations, the set of assets may include a set of content generated by an AI service comprising at least one ML model. This AI-generated content may include automated transcriptions, meeting summaries, action items, or other intelligent insights derived from the video conference. The ownership change operation may ensure that these AI-generated assets are properly assigned to the claiming participant's account, allowing them to leverage these advanced features within their personal or organizational workflows.

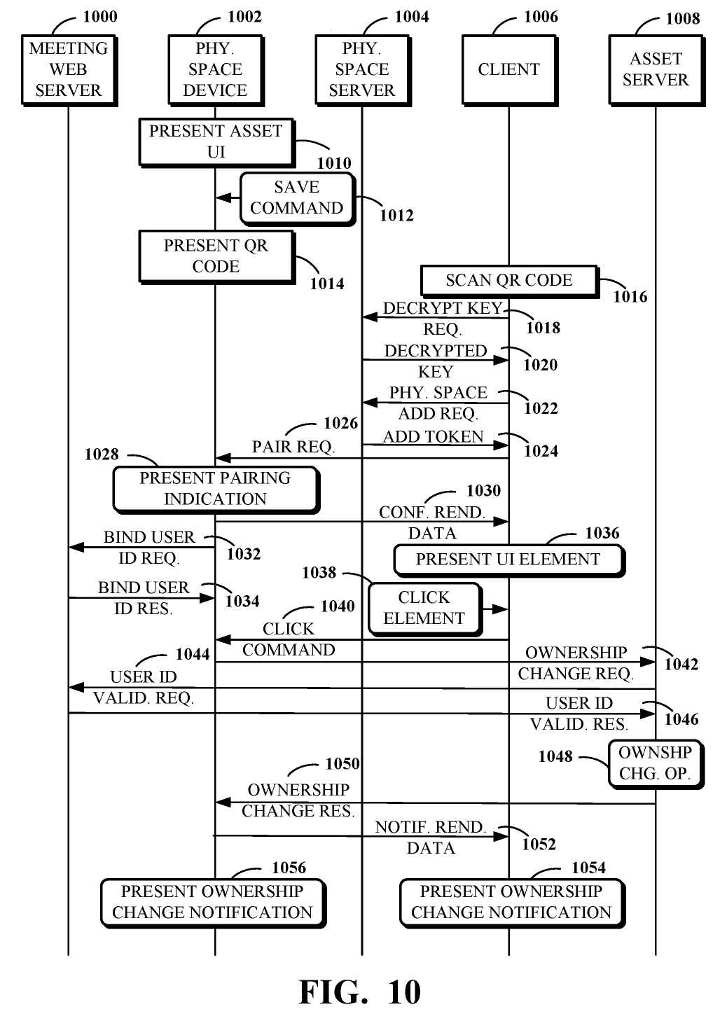

FIG. 10 is a flow diagram of an example corresponding to asset claiming associated with a software-based room system for video conferencing. The flow diagram illustrates interactions between a meeting web server 1000, a physical space device 1002, a physical space server 1004, a client 1006, and an asset server 1008.

In some implementations, at operation 1010, the physical space device 1002 may present an asset user interface. This interface may provide options for managing and claiming various meeting assets associated with the video conference. At operation 1012, a save command may be executed, which may initiate the asset claiming process.

In some implementations, the physical space device 1002 may present the asset user interface through a display component integrated within or connected to the device. This display may be a touchscreen, a large format display, or a projection system visible to participants in the physical conference space. The asset user interface may include a list of available meeting assets, such as recordings, transcripts, whiteboards, or AI-generated summaries. Each asset may be represented by an icon or thumbnail, along with relevant metadata like creation time or file size.

The interface may incorporate various interactive elements to enhance user experience. For instance, it may feature dropdown menus for sorting assets by type or date, search functionality to locate specific items, and preview options to quickly review content before claiming. The layout may be designed to be intuitive and responsive, adapting to different screen sizes and orientations.

In some cases, the asset user interface may be customizable, allowing administrators to tailor the appearance and available options based on organizational preferences or security policies. This customization may include branding elements, color schemes, or specific asset categories relevant to the organization's workflow.

The save command may be provided through multiple input methods to accommodate different user preferences and device capabilities. For example, users may initiate the save command by tapping or clicking a prominently displayed "Save" or "Claim Assets" button within the asset user interface; using voice commands, where the physical space device 1002 may be equipped with speech recognition capabilities; performing a specific gesture on a touchscreen or motion sensor, such as a swipe or multi-finger tap; selecting a save option from a context menu that appears when right-clicking or long-pressing on an asset; or using a dedicated hardware button on the physical space device 1002 or an associated remote control, among other examples.

In some implementations, the save command may be triggered automatically based on predefined rules or user preferences. For example, the system may prompt users to save assets at the end of a meeting or when detecting that a participant is about to leave the physical conference space. The physical space device 1002 may provide visual, auditory, or haptic feedback to confirm that the save command has been received and is being processed. This feedback may help users understand that their action has been recognized and the asset claiming process is underway.

Following the save command, at operation 1014, the physical space device 1002 may present a QR code. In some implementations, the physical space device 1002, which may be located within a physical conference space and connected to the video conference, may output QR code rendering data to cause a display device located within the physical conference space to present the QR code. This QR code may be associated with a set of assets related to the video conference.

At operation 1016, the client 1006, which may be a participant device located within the physical conference space, scans the QR code presented on the display. In some implementations, this scanning process may initiate a series of operations leading to the claiming of meeting assets. The client 1006 may send a decryption key request to the physical space server 1004 at operation 1018. In response, the physical space server 1004 may provide a decrypted key to the client 1006 at operation 1020.

Following the key exchange, the client 1006 may send a physical space add request to the physical space server 1004 at operation 1022. The physical space server 1004 may respond by providing an add token to the client 1006 at operation 1024. This token may be used to authenticate the client 1006 in subsequent operations.

At operation 1026, the client 1006 may send a pair request to the meeting web server 1000. In response, at operation 1028, the meeting web server 1000 may present a pairing indication, confirming the successful pairing between the client 1006 and the meeting web server 1000. In some implementations, determining a pairing between the participant device and the computing device may be a prerequisite for obtaining the claiming request.

The meeting web server 1000 may then provide confirmation rendering data to the client 1006 at operation 1030. This data may be used to configure the client 1006 for the asset claiming process. In parallel, the meeting web server 1000 may send a bind user ID request to the client 1006 at operation 1032. The client 1006 may respond with a bind user ID response at operation 1034, further authenticating the user's identity.

Based on the confirmation rendering data, the client 1006 may present a UI element at operation 1036. In some implementations, this UI element may be an interactive user interface element, such as a button or dialog box, prompting the user to confirm their intention to claim and save the meeting assets. At operation 1038, the client 1006 may obtain a click element command, which may be based on a user interaction with the interactive user interface element.

Following the user interaction, at operation 1040, the client 1006 may send a click command to the meeting web server 1000. This click command may be indicative of a claiming request corresponding to the set of assets associated with the video conference. The meeting web server 1000 may then initiate an ownership change operation at operation 1042 by transmitting, to the asset server 1008, an ownership change request. The asset server 1008 may be configured to manage access and ownership of meeting assets associated with the video conference. As part of the ownership change operation, the asset server 1008 may send a user ID validation request to the meeting web server 1000 at operation 1044. The meeting web server 1000 may respond with a user ID validation response at operation 1046, confirming the user's eligibility to claim the assets.

Upon successful validation, the asset server 1008 may perform an ownership change operation at operation 1048. This operation may facilitate the assignment of the set of assets to a participant account associated with the client 1006. In some implementations, where the set of assets includes a first asset and a second asset, the physical space device 1002 may provide a first ownership change request to a first asset server associated with the first asset and a second ownership change request to a second asset server associated with the second asset.

Following the ownership change operation, the asset server 1008 may send an ownership change response to the meeting web server 1000 at operation 1050. This response may confirm the successful transfer of ownership and provide any relevant details about the newly assigned assets. At operation 1052, the meeting web server 1000 may provide notification rendering data to the client 1006. This data may cause the client 1006 to present a notification indicative of completion of the ownership change operation at operation 1054. The meeting web server 1000 may present an ownership change notification at operation 1056, for example on a display visible to all participants in the physical conference space.

In some implementations, the set of assets may include a set of content generated by an AI service comprising at least one ML model. This AI-generated content may include automated transcriptions, meeting summaries, action items, or other intelligent insights derived from the video conference. The ownership change operation may facilitate proper assignment of AI-generated assets to the claiming participant's account.

In some implementations, based on the ownership change operation, the physical space device 1002 may assign host control of the video conference or a set of permissions associated with the video conference to the participant account. This may facilitate enhanced control by the claiming participant over the meeting and its associated assets.

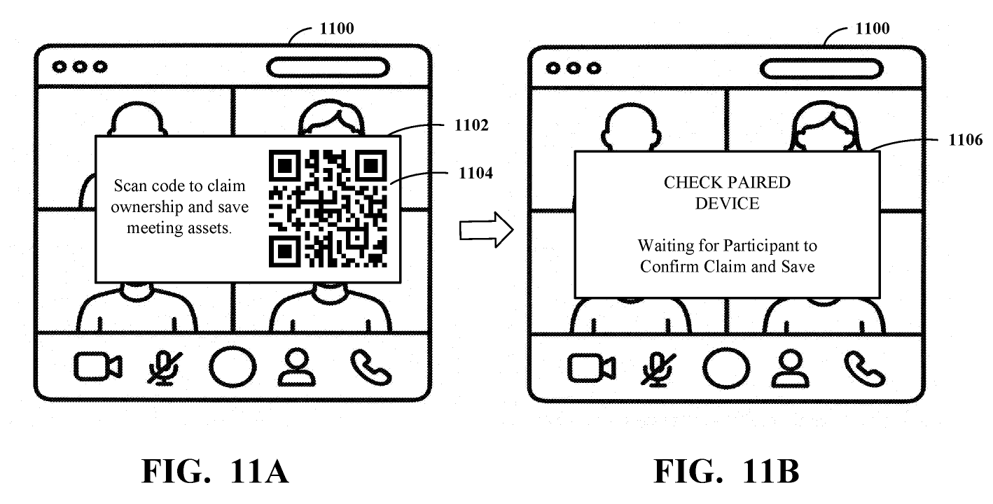

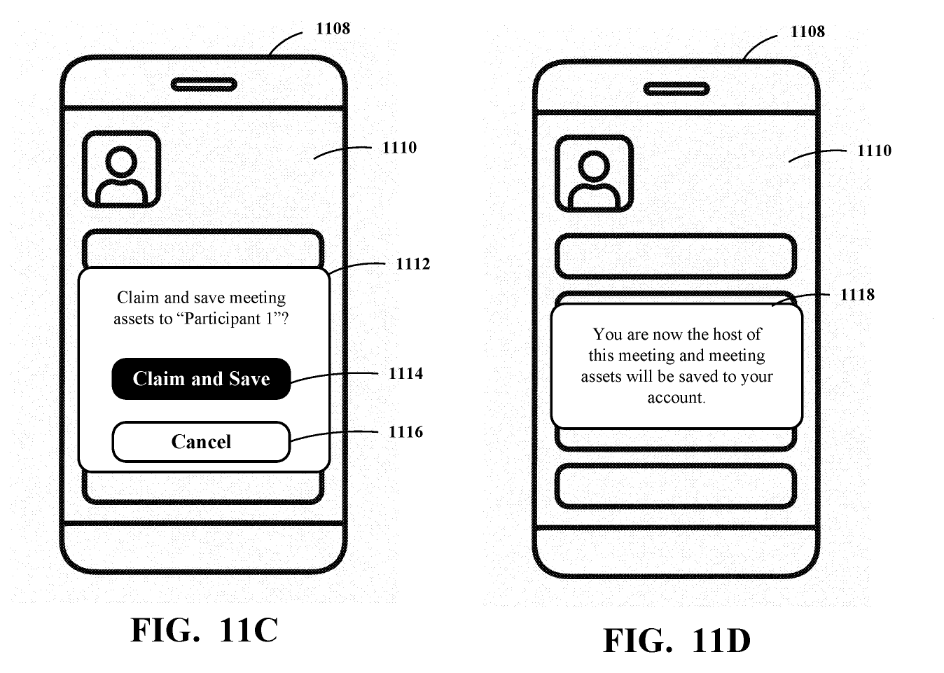

FIGS. 11A-11D are diagrams of example user interfaces corresponding to asset claiming associated with a software-based room system for video conferencing.

FIG. 11A illustrates a user interface 1100 displayed on a display device located within a physical conference space. The user interface 1100 includes a window 1102 that presents a QR code 1104. In some implementations, the QR code 1104 may be associated with a set of assets related to a video conference. The QR code 1104 may be presented in response to a physical space device, located within the physical conference space and connected to the video conference, outputting QR code rendering data to cause the display device to present the QR code 1104.

FIG. 11B depicts the user interface 1100 after a participant device has scanned the QR code 1104. The window 1102 now displays a notification 1106 indicating that the system is waiting for a participant to confirm a claim and save operation. This notification 1106 may be presented in response to the computing device determining a pairing between the participant device and the computing device.

FIG. 11C shows a participant device 1108 with a display 1110 presenting a window 1112. The window 1112 includes an interactive UI element 1114 labeled "Claim and Save" and a cancel button 1116. In some implementations, this interface may be presented on the participant device 1108 in response to the computing device outputting confirmation rendering data to the participant device 1108 based on scanning, by the participant device 1108 of the QR code 1104. The confirmation rendering data may cause the participant device 1108 to present the interactive user interface element 1114.

FIG. 11D illustrates the participant device 1108 with the display 1110 presenting a notification 1118. The notification 1118 may indicate completion of an ownership change operation. In some implementations, this notification 1118 may be presented in response to the computing device outputting notification rendering data to cause the participant device 1108 to present the notification 1118 indicative of completion of the ownership change operation.

The sequence of user interfaces shown in FIGS. 11A-11D may facilitate a streamlined process for claiming and saving meeting assets in a video conferencing environment. A participant may initiate the claiming process by scanning the QR code 1104 presented in FIG. 11A using their participant device 1108. This scanning action may result in the pairing between the participant device 1108 and the computing device located within the physical conference space. Following the pairing, the participant may be presented with the interactive UI element 1114 shown in FIG. 11C. In some implementations, the participant's interaction with this UI element may generate a click command. The click command may be obtained by the computing device from the participant device 1108 and may be indicative of a claiming request corresponding to a set of assets associated with the video conference.

Based on the click command, the computing device may facilitate an ownership change operation to assign the set of assets to a participant account associated with the participant device 1108. The notification 1118 shown in FIG. 11D may serve as confirmation that this ownership change operation has been completed successfully. In some implementations, the set of assets assigned through this process may include at least one of a recording associated with the video conference, a virtual meeting summary associated with the video conference, or a virtual meeting whiteboard associated with the video conference. The ownership change operation may involve providing an ownership change request to an asset server associated with the set of assets.

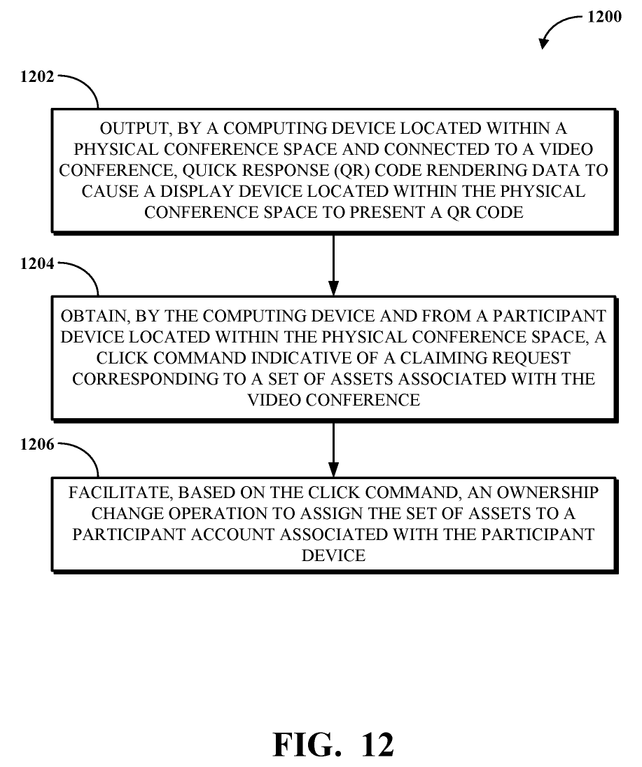

To further describe some implementations in greater detail, reference is next made to examples of techniques which may be performed by or using a software-based room system for video conferencing as described herein. FIG. 12 is a flowchart of an example of a technique 1200 associated with asset claiming in a video conferencing environment. The technique 1200 can be executed using computing devices, such as the systems, hardware, and software described with respect to FIGS. 1-11. The technique 1200 can be performed, for example, by executing a machine-readable program or other computer-executable instructions, such as routines, instructions, programs, or other code. The steps, or operations, of the technique 1200, or another technique, method, process, or algorithm described in connection with the implementations disclosed herein can be implemented directly in hardware, firmware, software executed by hardware, circuitry, or a combination thereof.

For simplicity of explanation, the technique 1200 is depicted and described herein as a series of steps or operations. However, the steps or operations of the technique 1200 can occur in various orders and/or concurrently. Additionally, other steps or operations not presented and described herein may be used. Furthermore, not all illustrated steps or operations may be required to implement a technique in accordance with the disclosed subject matter.

At step 1202, the technique 1200 may include outputting, by a computing device located within a physical conference space and connected to a video conference, QR code rendering data to cause a display device located within the physical conference space to present a QR code. In some implementations, the computing device may be a physical space device, such as the physical space device 602 shown in FIG. 6. The display device may be one of the displays 1 610 through N 612 shown in FIG. 6. The QR code may be associated with a set of assets related to the video conference.

In some implementations, prior to outputting the QR code rendering data, the computing device may perform a sharing key encryption operation to generate the QR code. This operation may involve creating a unique sharing key associated with the video conference and the set of assets to be claimed. The sharing key may include information such as a conference identifier, asset identifiers, and a timestamp. The computing device may encrypt this sharing key using a cryptographic algorithm, which may enhance security by preventing unauthorized access to the conference assets.

The QR code may be presented on the display device in various ways. In some implementations, the QR code may be prominently displayed to ensure visibility to all participants in the room. The computing device may adjust the size, resolution, or contrast of the QR code to facilitate readability across various lighting conditions and viewing distances within the physical conference space. In some cases, the QR code may be presented alongside contextual information, such as instructions for scanning or a brief explanation of the asset claiming process.

At step 1204, the technique 1200 may include obtaining, by the computing device and from a participant device located within the physical conference space, a click command indicative of a claiming request corresponding to a set of assets associated with the video conference. In some implementations, the participant device may be one of the companion devices 1 614 through N 616 shown in FIG. 6. The click command may be generated based on a user interaction with an interactive user interface element presented on the participant device.

In some implementations, prior to obtaining the click command, the computing device may determine a pairing between the participant device and the computing device. This pairing may be established using various technologies, such as Bluetooth, Wi-Fi, or ultrasonic signals. The pairing process may enable secure communication between the devices and form the basis for subsequent asset claiming operations.

Following the pairing, the computing device may output confirmation rendering data to the participant device. This confirmation rendering data may cause the participant device to present an interactive user interface element, such as a button or dialog box, prompting the user to confirm their intention to claim and save the meeting assets. The click command obtained by the computing device may be based on the user's interaction with this interactive user interface element.

At step 1206, the technique 1200 may include facilitating, based on the click command, an ownership change operation to assign the set of assets to a participant account associated with the participant device. In some implementations, facilitating the ownership change operation may involve providing an ownership change request to an asset server associated with the set of assets. The asset server may be configured to manage access and ownership of meeting assets associated with the video conference.

In some implementations, where the set of assets includes a first asset and a second asset, the computing device may provide a first ownership change request to a first asset server associated with the first asset and a second ownership change request to a second asset server associated with the second asset. This approach may facilitate granular control and management of different types of meeting assets across multiple asset servers.

The set of assets may include at least one of a recording associated with the video conference, a virtual meeting summary associated with the video conference, or a virtual meeting whiteboard associated with the video conference. In some implementations, the set of assets may include a set of content generated by an AI service comprising at least one ML model. This AI-generated content may include automated transcriptions, meeting summaries, action items, or other intelligent insights derived from the video conference.

Following the ownership change operation, the computing device may output notification rendering data to cause the participant device or the display device to present a notification indicative of completion of the ownership change operation. This notification may provide visual confirmation to the user that the set of assets has been successfully assigned to their participant account.

In some implementations, based on the ownership change operation, the computing device may assign host control of the video conference to the participant account associated with the participant device. This may facilitate enhanced control by the claiming participant over the meeting and its associated assets. In some implementations, the computing device may assign a set of permissions associated with the video conference to the participant account based on the ownership change operation.

The technique 1200 may be implemented using various hardware and software components. For example, the computing device may include one or more processors configured to execute instructions stored in one or more memories to perform the operations described. Similarly, the asset server may include one or more processors and memories configured to manage the video conference assets and process ownership change requests.

Some implementations include a method, comprising: outputting, by a computing device located within a physical conference space and connected to a video conference, quick response (QR) code rendering data to cause a display device located within the physical conference space to present a QR code; obtaining, by the computing device and from a participant device located within the physical conference space, a click command indicative of a claiming request corresponding to a set of assets associated with the video conference; and facilitating, based on the click command, an ownership change operation to assign the set of assets to a participant account associated with the participant device.

In some implementations, the method further includes: determining a pairing between the participant device and the computing device, wherein obtaining the claiming request is based on the pairing.

In some implementations, the method further includes: determining a pairing between the participant device and the computing device; and outputting, to the participant device, confirmation rendering data to cause the participant device to present an interactive user interface element, wherein the click command is based on a user interaction with the interactive user interface element.

In some implementations, facilitating the ownership change operation comprises: providing, to an asset server associated with the set of assets, an ownership change request.

In some implementations, the method further includes: outputting notification rendering data to cause the participant device to present a notification indicative of completion of the ownership change operation.

In some implementations, the method further includes: outputting notification rendering data to cause the display device to present a notification indicative of completion of the ownership change operation.

In some implementations, the set of assets comprises at least one of a recording associated with the video conference, a virtual meeting summary associated with the video conference, or a virtual meeting whiteboard associated with the video conference.

In some implementations, the method further includes: assigning, based on the ownership change operation, host control of the video conference to the participant account

Some implementations include a non-transitory computer-readable medium storing instructions operable to cause one or more processors to perform operations comprising: outputting, by a computing device located within a physical conference space and connected to a video conference, quick response (QR) code rendering data to cause a display device located within the physical conference space to present a QR code; obtaining, by the computing device and from a participant device located within the physical conference space, a click command indicative of a claiming request corresponding to a set of assets associated with the video conference; and facilitating, based on the click command, an ownership change operation to assign the set of assets to a participant account associated with the participant device.

In some implementations, obtaining the claiming request is based on a pairing between the participant device and the computing device.

In some implementations, the operations further include: outputting, to the participant device and based on a pairing between the participant device and the computing device, confirmation rendering data to cause the participant device to present an interactive user interface element, wherein the click command is based on a user interaction with the interactive user interface element.

In some implementations, facilitating the ownership change operation comprises: providing an ownership change request to at least one asset server associated with the set of assets.

In some implementations, the set of assets comprises a first asset and a second asset, and facilitating the ownership change operation comprises: providing a first ownership change request to a first asset server associated with the first asset; and providing a second ownership change request to a second asset server associated with the second asset.

In some implementations, the set of assets comprises a set of content generated by an artificial intelligence service comprising at least one machine learning model.

In some implementations, the operations further include: assigning, based on the ownership change operation, a set of permissions associated with the video conference to the participant account.

Some implementations include a system, comprising: one or more memories; and one or more processors configured to execute instructions stored in the one or more memories to cause the system to: output, by a computing device located within a physical conference space and connected to a video conference, quick response (QR) code rendering data to cause a display device located within the physical conference space to present a QR code; obtain, by the computing device and from a participant device located within the physical conference space, a click command indicative of a claiming request corresponding to a set of assets associated with the video conference; and facilitate, based on the click command, an ownership change operation to assign the set of assets to a participant account associated with the participant device.

In some implementations, the one or more processors are configured to execute the instructions to further cause the system to: determine a pairing between the participant device and the computing device, wherein the claiming request is obtained based on the pairing.

In some implementations, to facilitate the ownership change operation, the one or more processors are configured to execute the instructions to further cause the system to: provide, to an asset server associated with the set of assets, an ownership change request.

In some implementations, the set of assets comprises a first asset and a second asset, and, to facilitate the ownership change operation, the one or more processors are configured to execute the instructions to further cause the system to: provide a first ownership change request to a first asset server associated with the first asset; and provide a second ownership change request to a second asset server associated with the second asset.

In some implementations, the one or more processors are configured to execute the instructions to further cause the system to: assign, based on the ownership change operation, a set of permissions associated with the video conference to the participant account.

As used herein, unless explicitly stated otherwise, any term specified in the singular may include its plural version. For example, “a computer that stores data and runs software,” may include a single computer that stores data and runs software or two computers – a first computer that stores data and a second computer that runs software. Also “a computer that stores data and runs software,” may include multiple computers that together stored data and run software. At least one of the multiple computers stores data, and at least one of the multiple computers runs software.

As used herein, the term “computer-readable medium” encompasses one or more computer readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

As used herein, the term “memory subsystem” includes one or more memories, where each memory may be a computer-readable medium. A memory subsystem may encompass memory hardware units (e.g., a hard drive or a disk) that store data or instructions in software form. Alternatively or in addition, the memory subsystem may include data or instructions that are hard-wired into processing circuitry.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory subsystem and hardware that is hard-wired into the processing circuitry.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
outputting, by a computing device located within a physical conference space and connected to a video conference, quick response (QR) code rendering data to cause a display device located within the physical conference space to present a QR code;
obtaining, by the computing device and from a participant device located within the physical conference space, a click command indicative of a claiming request corresponding to a set of assets associated with the video conference; and
facilitating, based on the click command, an ownership change operation to assign the set of assets to a participant account associated with the participant device.

2. The method of claim 1, further comprising:
determining a pairing between the participant device and the computing device, wherein obtaining the claiming request is based on the pairing.

3. The method of claim 1, further comprising:
determining a pairing between the participant device and the computing device; and
outputting, to the participant device, confirmation rendering data to cause the participant device to present an interactive user interface element, wherein the click command is based on a user interaction with the interactive user interface element.

4. The method of claim 1, wherein facilitating the ownership change operation comprises:
providing, to an asset server associated with the set of assets, an ownership change request.

5. The method of claim 1, further comprising:
outputting notification rendering data to cause the participant device to present a notification indicative of completion of the ownership change operation.

6. The method of claim 1, further comprising:
outputting notification rendering data to cause the display device to present a notification indicative of completion of the ownership change operation.

7. The method of claim 1, wherein the set of assets comprises at least one of a recording associated with the video conference, a virtual meeting summary associated with the video conference, or a virtual meeting whiteboard associated with the video conference.

8. The method of claim 1, further comprising:
assigning, based on the ownership change operation, host control of the video conference to the participant account.

9. A non-transitory computer-readable medium storing instructions operable to cause one or more processors to perform operations comprising:
outputting, by a computing device located within a physical conference space and connected to a video conference, quick response (QR) code rendering data to cause a display device located within the physical conference space to present a QR code;
obtaining, by the computing device and from a participant device located within the physical conference space, a click command indicative of a claiming request corresponding to a set of assets associated with the video conference; and
facilitating, based on the click command, an ownership change operation to assign the set of assets to a participant account associated with the participant device.

10. The non-transitory computer-readable medium of claim 9, wherein obtaining the claiming request is based on a pairing between the participant device and the computing device.

11. The non-transitory computer-readable medium of claim 9, the operations further comprising:
outputting, to the participant device and based on a pairing between the participant device and the computing device, confirmation rendering data to cause the participant device to present an interactive user interface element, wherein the click command is based on a user interaction with the interactive user interface element.

12. The non-transitory computer-readable medium of claim 9, wherein facilitating the ownership change operation comprises:
providing an ownership change request to at least one asset server associated with the set of assets.

13. The non-transitory computer-readable medium of claim 9, wherein the set of assets comprises a first asset and a second asset, and wherein facilitating the ownership change operation comprises:
providing a first ownership change request to a first asset server associated with the first asset; and
providing a second ownership change request to a second asset server associated with the second asset.

14. The non-transitory computer-readable medium of claim 9, wherein the set of assets comprises a set of content generated by an artificial intelligence service comprising at least one machine learning model.

15. The non-transitory computer-readable medium of claim 9, the operations further comprising:
assigning, based on the ownership change operation, a set of permissions associated with the video conference to the participant account.

16. A system, comprising:
one or more memories; and
one or more processors configured to execute instructions stored in the one or more memories to cause the system to:
output, by a computing device located within a physical conference space and connected to a video conference, quick response (QR) code rendering data to cause a display device located within the physical conference space to present a QR code;
obtain, by the computing device and from a participant device located within the physical conference space, a click command indicative of a claiming request corresponding to a set of assets associated with the video conference; and
facilitate, based on the click command, an ownership change operation to assign the set of assets to a participant account associated with the participant device.

17. The system of claim 16, wherein the one or more processors are configured to execute the instructions to further cause the system to:
determine a pairing between the participant device and the computing device, wherein the claiming request is obtained based on the pairing.

18. The system of claim 16, wherein, to facilitate the ownership change operation, the one or more processors are configured to execute the instructions to further cause the system to:
provide, to an asset server associated with the set of assets, an ownership change request.

19. The system of claim 16, wherein the set of assets comprises a first asset and a second asset, and wherein, to facilitate the ownership change operation, the one or more processors are configured to execute the instructions to further cause the system to:
provide a first ownership change request to a first asset server associated with the first asset; and
provide a second ownership change request to a second asset server associated with the second asset.

20. The system of claim 16, wherein the one or more processors are configured to execute the instructions to further cause the system to:
assign, based on the ownership change operation, a set of permissions associated with the video conference to the participant account.
